(19) United States
(12) Patent Application Publication
(10) Pub. No.: US 2022/0168804 A1
(43) Pub. Date: Jun. 2, 2022

(54) METAL NANOSTRUCTURE PURIFICATION

(71) Applicant: Cambrios Film Solutions Corporation, Tortola (VG)

(72) Inventors: Leize ZHU, San Jose, CA (US); Ian Storms MOODY, Soquel, CA (US); Samuel Lumahan ROBILLOS, Milpitas, CA (US)

(21) Appl. No.: 17/600,708

(22) PCT Filed: Apr. 1, 2020
(86) PCT No.: PCT/US2020/026057

§ 371 Date: Oct. 1, 2021

Related U.S. Application Data
(60) Provisional application No. 62/828,613, filed on Apr. 3, 2019.

(51) Int. Cl. B22F 1/148; C08K 7/06; C08L 1/28; B01D 21/01; B22F 1/054; B22F 9/24

(52) U.S. Cl. CPC B22F 1/148; C08K 7/06; C08L 1/284; B01D 21/01; H01B 1/22; B22F 9/24; C08K 2201/011; C08K 2201/001; C08K 2201/016; B22F 1/0547

(57) ABSTRACT

A method of purifying a composition including metal nanostructures. The method includes combining the composition and a water-miscible polymer to form a combination that promotes an agglomeration of the metal nanostructures in the combination over an agglomeration of low-aspect-ratio nanostructures in the combination. The method includes subjecting the combination to a sedimentation process to form a sediment layer including a concentration of the metal nanostructures that is greater than a previous concentration of the metal nanostructures in the combination.

### RELATED APPLICATION

This application claims priority to U.S. Provisional Application Ser. No. 62/828,613, titled “METAL NANOSTRUCTURE PURIFICATION” and filed on Apr. 3, 2019, which is incorporated herein by reference.

### FIELD

This disclosure is related to purification of metal nanostructures and transparent conductors made from the purified metal nanostructures.

### BACKGROUND

Transparent conductors include optically-clear and electrically-conductive films. Silver nanowires (AgNWs) are an example nanostructure. One of the example applications for AgNWs today is in forming transparent conductor (TC) layers in electronic devices, such as touch panels, photovoltaic cells, flat liquid crystal displays (LCD), organic light emitting diodes (OLED), wearable devices, etc. In general, various technologies have produced transparent conductors based on one or more conductive media such as conductive nanostructures. Generally, the conductive nanostructures form a conductive network through long-range interconnectivity.

As the number of applications employing transparent conductors continues to grow, improved production methods are required to satisfy the demand for conductive nanostructures. Traditional purification techniques attempt to reduce the levels of undesired contaminants through sedimentation. However, conventional sedimentation techniques are not suitable at scales larger than benchtop because of the limited productivity of sedimentation as a result of long settling times required for adequate separation of the conductive nanostructures from the undesired contaminants.

### BRIEF SUMMARY

In accordance with an aspect, a method of purifying a composition including metal nanostructures is provided. The method includes combining the composition and a water-miscible polymer to form a combination that promotes an agglomeration of the metal nanostructures in the combination over an agglomeration of low-aspect-ratio nanostructures in the combination. The method includes subjecting the combination to a sedimentation process to form a sediment layer including a concentration of the metal nanostructures that is greater than a previous concentration of the metal nanostructures in the combination.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

The disclosed subject matter may take physical form in certain parts and arrangement of parts, embodiments of which will be described in detail in this specification and illustrated in the accompanying drawings which form a part hereof and wherein:

FIG. 1 is a flow chart illustrating an example of a method of polymeric-assisted sedimentation for purifying a mixture including metallic nanowires and low-aspect-ratio nanostructures in accordance with the present disclosure.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

Certain terminology is used herein for convenience only and is not to be taken as a limitation on the disclosed subject matter. Relative language used herein is best understood with reference to the drawings, in which like numerals are used to identify like or similar items. Further, in the drawings, certain features may be shown in somewhat schematic form.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

Provided herein is a method of isolating and purifying conductive nanostructures from a process mixture. As used herein, “conductive nanostructures” or “nanostructures” generally refer to electrically conductive nano-sized structures, at least one dimension of which is less than 500 nm, or less than 250 nm, 100 nm, 50 nm, 25 nm, 15 nm, or 10 nm for example. Typically, the nanostructures are made of a metallic material, such as an elemental metal (e.g., transition metals) or a metal compound (e.g., metal oxide). The metallic material can also be a bimetallic material or a metal alloy, which comprises two or more types of metal. Suitable metals include, but are not limited to, silver, gold, copper, nickel, gold-plated silver, platinum and palladium.

The nanostructures can be of any shape or geometry. The morphology of a given nanostructure can be defined in a simplified fashion by its aspect ratio, which is the ratio of the length over the diameter of the nanostructure. For instance, certain nanostructures are isotropically shaped (i.e., aspect ratio=1). Typical isotropic nanostructures include nanoparticles. In preferred embodiments, the nanostructures are anisotropically shaped (i.e., aspect ratio≠1). The anisotropic nanostructure typically has a longitudinal axis along its length. Exemplary anisotropic nanostructures include nanowires, nanorods, and nanotubes, as defined herein.

The nanostructures can be solid or hollow. Solid nanostructures include, for example, nanoparticles, nanorods and nanowires (“NWs”). NWs typically refers to long, thin nanostructures having aspect ratios of greater than 10, preferably greater than 50, and more preferably greater than 100. Typically, the nanowires are more than 500 nm, more than 1 μm, or more than 10 μm long. “Nanorods” are typically short and wide anisotropic nanostructures that have aspect ratios of no more than 10. Although the present disclosure is applicable to purifying any type of nanostructure, for the sake of brevity the purification of silver nanowires (“AgNWs” or abbreviated simply as “NWs”) will be described as an example.

Many electronic applications depend on the electrical and optical properties of the TC layer to achieve their desired performance. Such applications typically require TCs with high electrical conductivity, high optical transmission, and low haze, as preferred attributes. Electrical and optical properties of a TC layer are dependent on the physical dimensions of NWs—i.e. their length and diameter, and more generally, their aspect ratio. NWs with larger aspect ratios form a more efficient conductive network by allowing a lower density of wires to achieve higher transparency for a given film resistivity. Because each NW can be considered a conductor, individual NW length and diameter will affect the overall NW network conductivity and, therefore, the final film conductivity. For example, as nanowires get longer, fewer are needed to make a conductive network; and as NWs get thinner, NW resistivity increases—making the resulting film less conductive for a given number of NWs.

Similarly, NW length and diameter will affect the optical transparency and light diffusion (haze) of the TC layers. NW networks are optically transparent because nanowires comprise a very small fraction of the film. However, the nanowires absorb and scatter light, so NW length and diameter will, in large part, determine optical transparency and haze for a conductive NW network. Generally, thinner NWs enable increased transmission and reduced haze in TC layers—desired properties for electronic applications.

Many synthetic processes used to manufacture NWs also produce a variety of low-aspect-ratio nanostructures as byproducts. These low-aspect-ratio nanostructures (e.g. nanoparticles, nanorods, microparticles, etc.) create added haze in the TC layer, as these structures scatter light without contributing to the conductivity of the network. As such, crude NW suspensions typically require additional processing (i.e. purification steps) to remove these byproducts from the NW suspension before processing into a TC layer.

However, NWs can be synthesized with ever-smaller diameters (e.g., in the range of tens of nanometers), and these smaller diameters closely match the dimensions of the undesired byproducts such as low aspect ratio nanostructures. The byproducts scatter light without contributing to the conductivity of the network, resulting in added haze in the TC layer. To limit this haze, at least a portion of the byproducts should be removed from the composition including the NWs. But due to the similarity in size, composition, and structure between the NWs and the byproducts, purifying high-aspect-ratio NWs for high-quality TC films is a challenge.

This disclosure describes a purification method for use in purifying NW suspensions, including those suspensions containing high-aspect ratio NWs. Embodiments of the method involve utilizing a viscosity-modifying, water-miscible polymer to induce reversible NW agglomeration, and act as a sedimentation aid in the preferential sedimentation of NWs over low-aspect-ratio nanostructures. The preferential sedimentation behavior allows for efficient, high-throughput purification of NWs with reductions in byproduct concentrations of 20×, or greater.

The NWs can be produced by a solution-based synthesis, for example, the “polyol” process, that is reasonably effective in large-scale production of metal nanostructures. See, e.g., Sun, Y. et al., (2002) Science, 298, 2176; Sun, Y. et al., (2002) Nano Lett. 2, 165. The polyol process involves the reduction of a precursor (e.g., a metal salt) of the metal nanostructure by a polyol, an organic compound comprising at least two hydroxyl groups (e.g., ethylene glycol), in the presence of polyvinyl pyrrolidone (“PVP”). Typically, the polyol serves the dual functions of the reducing agent as well as the solvent. Exemplary polyols include, but are not limited to, ethylene glycol, 1,2-propylene glycol, 1,3-propylene glycol, and glycerol.

Although the polyol process may be optimized to produce predominately NWs, in reality, a complex collection of nanostructures are formed as reaction byproducts. For example, besides NWs, metal or metal halide nanostructures of various morphologies, including nanoparticles, nanocubes, nanorods, nanopyramids and multiply-twinned particles, may also be produced. The problem is compounded by poor reproducibility of the process, which is believed to be caused by trace amounts of contaminants in the constituents of the synthesis.

As discussed herein, to form a TC in which nanostructures form a conductive network, it may be desirable to reduce the amount of byproduct nanostructures present, other than NWs, because the other nanostructures may not effectively contribute to conductivity, and their presence may contribute to haze. As used herein, “low aspect ratio nanostructures” or “contaminants,” includes, for example, nanostructures that are relatively wide and/or short (e.g., nanoparticles, nanorods), and have a relatively small aspect ratio (<10). Some or all of these low aspect ratio nanostructures may be seen as “bright objects” in a conductive film due to their bright appearance on dark field micrographs. The bright objects may, thus, significantly increase the haze of the conductive film.

Isolating NWs from the contaminants in a reaction mixture of crude products has proved to be difficult or inefficient. In particular, an isolation method may involve sedimentation, which allows for the nanostructures to precipitate while a liquid phase including the polyol and PVP forms the supernatant. However, the contaminants commonly co-precipitate with the NWs and become very difficult to separate. In addition, the co-precipitated NWs and the contaminants are often difficult to be re-suspended in a liquid phase, impeding any effort of further purification. Moreover, certain polyol solvents are so viscous at room temperature (e.g., glycerol) that a protracted sedimentation process may be necessary before any appreciative amount of nanostructures can precipitate.

Embodiments provide a post-synthesis purification method that isolates NWs from a crude reaction mixture that includes the NWs in addition to contaminants such as metal nanostructures having aspect ratios of less than 10 (e.g., nanoparticles and nanorods). The purification process involves the introduction of a viscosity-modifying, water-miscible polymer polysaccharide such as, for example, dextrin, starch, chitin, chitosan, glycogen, cellulose, etc., to the reaction mixture including the NWs and contaminants. The introduction of the polysaccharide is believed to overcome at least some of the limitations associated with traditional gravity-based sedimentation processes (e.g., offers improved precipitation rate) and is scalable to high volume production. Moreover, in particular, the purification process involves using a viscosity-modifying, water-miscible polymer polysaccharide to induce reversible NW agglomeration, and act as a sedimentation aid in the preferential sedimentation of NWs over low-aspect-ratio nanostructures.

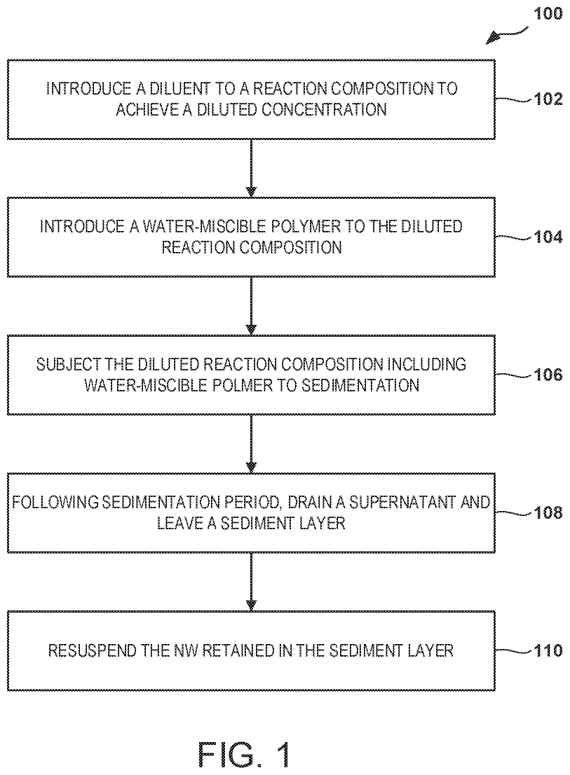

FIG. 1 is a flow chart illustrating an example embodiment of a method 100 of polymeric-assisted sedimentation for purifying a mixture including metallic NWs, as one example nanostructure, and low-aspect-ratio nanostructures. As such, the example of the method is performed concerning purification focused upon NWs. However, it is to be appreciated that the example method is applicable for purification focused other nanostructures.

As an example precursor to the example method according to the present disclosure, a reaction composition is produced by a polyol process includes a combination of NWs and low-aspect-ratio nanostructures in a liquid medium (e.g., ethylene glycol and water, water, etc.). Of course, the example precursor can be varied, provided in a variety of ways, etc., and as such is not a limitation upon the present disclosure.

At step 102 of the method 100, the reaction composition is diluted, if necessary, by introducing a suitable quantity of a diluent (e.g., de-ionized water) to the reaction composition to establish a metal (e.g., silver) concentration of 0.04 wt % or greater, up to concentrations that are equal to or less than 2.5 wt %. It is to be appreciated that step 102 could be considered optional (e.g., if the composition already has an acceptable state of dilution, etc.).

A water-miscible polymer, for example such as hydroxypropyl methylcellulose (“HPMC”), is introduced to the diluted reaction composition at step 104, and the composition is mixed. A suitable quantity of HPMC or other polymeric material is introduced to establish a polymeric concentration of at least 0.02 wt %, up to concentrations that are equal to or less than 0.30 wt %. HPMC combined with the liquid medium of the diluted reaction composition exhibits viscoelastic properties that increases the viscosity of the diluted reaction composition from an original viscosity exhibited by the diluted reaction composition prior to the addition of the HPMC. The poor solubility of HPMC in the ethylene glycol/water mixture is believed to promote agglomeration of the NWs in the diluted reaction composition, and the sedimentation of the aggregated NWs from the diluted reaction composition.

The diluted reaction composition with the added HPMC is subjected to sedimentation at step 106. Various sedimentation techniques, devices, etc. can be employed. For example, a sedimentation height of between 2 and 20 mm, or other desired height, is established in a sedimentation container, and allowed to rest undisturbed for a sedimentation period of days, for example 1-5 days or as further examples up to 21 days. The specifics of the sedimentation need not be a specific limitation upon the present disclosure.

As an optional, but logical next step following the sedimentation period, the supernatant is drained at step 108, leaving behind a sediment layer containing NWs in agglomerated bundles that settled from than the diluted reaction composition. The majority of the NWs settle, with the concentration of NWs in the sediment being greater than the concentration of NWs left behind in the supernatant. The drained supernatant includes primarily low-aspect-ratio nanostructures as a result of the preference of the HPMC or other polymeric substance to agglomerate the NWs over the low-aspect-ratio nanostructures. Embodiments of the NW concentration in the sediment layer can be at least 10×, or optionally at least 15×, or optionally at least 20× greater than concentration of NWs in the reaction composition or the diluted reaction composition.

At step 110, the NWs remaining in the sediment layer can optionally be re-suspended in an aqueous solution (e.g., de-ionized water). If further purification of the NW concentration in the aqueous solution is desired, the above process can be repeated starting with the aqueous solution as the reaction mixture. Of course, it is to be appreciated that variations regarding re-suspension are possible and contemplated. For example, resuspension could be via use of an alcohol, such as methanol, ethanol, isopropyl alcohol (IPA), etc.

Typically, in the as synthesized crude reaction mixture, the ratio of the low-aspect-ratio nanostructures to NWs is in the range of 2 to 15. The low aspect ratio nanostructures have aspect ratios of less than 10 (e.g., nanoparticles and nanorods). After the above sedimentation purification process, the ratio of the low-aspect-ratio nanostructures to NWs is greatly reduced, preferably less than 0.8, preferably less than 0.5, preferably less than 0.2, or preferably less than 0.1.

It is to be appreciated that the example method 100 can be modified and need not be a limitation upon the present disclosure. For example, some of the steps of the example method can be optional, modified, performed in a different order/simultaneous, etc.

As an example of a method for which steps are optional/modified, a method in accordance with the present disclosure can be as follows: a method of purifying a composition including metal nanostructures. The method includes combining the composition and a water-miscible polymer to form a combination that promotes an agglomeration of the metal nanostructures in the combination over an agglomeration of low-aspect-ratio nanostructures in the combination, and subjecting the combination to a sedimentation process to form a sediment layer comprising a concentration of the metal nanostructures that is greater than a previous concentration of the metal nanostructures in the combination.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or.” In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” and/or variants thereof are used in either the detailed description or the claims, such terms are intended to be inclusive in a manner similar to the term “comprising.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method of purifying a composition including metal nanostructures, the method comprising:
combining the composition and a water-miscible polymer to form a combination that promotes an agglomeration of the metal nanostructures in the combination over an agglomeration of low-aspect-ratio nanostructures in the combination; and
subjecting the combination to a sedimentation process to form a sediment layer comprising a concentration of the metal nanostructures that is greater than a previous concentration of the metal nanostructures in the combination, wherein the water-miscible polymer modifies a viscosity of the composition and the concentration of the metal nanostructures in the sediment layer is at least 10 times higher than a concentration of the metal nanostructures in the composition.

2. The method of claim 1, wherein the water-miscible polymer comprises hydroxypropyl methylcellulose.

3. (canceled)

4. The method of claim 1, including introducing a diluent to the composition to achieve a diluted concentration.

5. The method of claim 4, wherein the step of introducing a diluent to the composition occurs prior to the step of combining the composition and a water-miscible polymer.

6. (canceled)

7. The method of claim 1, including draining supernatant from the sediment layer.

8. The method of claim 1, including resuspending the metal nanostructures retained within the sediment layer.

9. The method of claim 1, wherein the metal nanostructures include silver metal.

10. The method of claim 1, wherein the metal nanostructures include nanowires.

11. The method of claim 1, wherein after the step of subjecting the combination to a sedimentation process, a ratio of the low-aspect-ratio nanostructures to the metal nanostructures is less than 0.8.

12. The method of claim 1, wherein after the step of subjecting the combination to a sedimentation process, a ratio of the low-aspect-ratio nanostructures to the metal nanostructures is less than 0.5.

13. The method of claim 1, wherein after the step of subjecting the combination to a sedimentation process, a ratio of the low-aspect-ratio nanostructures to the metal nanostructures is less than 0.2.

14. The method of claim 1, wherein after the step of subjecting the combination to a sedimentation process, a ratio of the low-aspect-ratio nanostructures to the metal nanostructures is less than 0.1.

15. The method of claim 1, wherein the low-aspect-ratio nanostructures have aspect ratios of less than 10.

16. The method of claim 1, wherein the low-aspect-ratio nanostructures include nanoparticles.

17. The method of claim 1, wherein the low-aspect-ratio nanostructures include nanorods.
